(19) United States
(12) Patent Application Publication
(10) Pub. No.: US 2004/0035626 A1
(43) Pub. Date: Feb. 26, 2004

(54) Vehicle and adjustable steering shaft therefor

(76) Inventors: Bruno Girouard, Montreal (CA); Berthold Fecteau, Richmond (CA); Anne-Marie Dion, Granby (CA); Jerome Wubbolts, Orford (CA)

Correspondence Address: PILLSBURY WINTHROP, LLP, P.O. BOX 10500, MCLEAN, VA, 22102, US

(21) Appl. No.: 10/371,233

(22) Filed: Feb. 24, 2003

Related U.S. Application Data
(60) Provisional application No. 60/358,397, filed on Feb. 22, 2002.
(60) Provisional application No. 60/358,400, filed on Feb. 22, 2002.

(51) Int. Cl. B62K 5/02

(52) U.S. Cl. 180/210

(57) ABSTRACT

A vehicle includes a frame, an engine supported on the frame, and straddle-type seat disposed on the frame. The frame includes tubular members that interconnect to create a strong, light, rigid frame assembly. A steering bracket is provided on the frame that allows for variable positioning of a steering shaft operatively connected to a handlebar mechanism to define a plurality of handlebar mechanism positions. The steering shaft has an offset portion that allows the steering shaft to remain spaced from an engine when the handlebar mechanism is moved to a position closer to the rear of the vehicle.

This application claims priority to U.S. Provisional Applications 60/358,397 and 60/358,400, both filed Feb. 22, 2002, the entire contents of which are herein incorporated by reference. This application is related, but does not claim priority, to U.S. application Ser. No. 09/877,212, filed Jun. 11, 2001, the entire contents of which are herein incorporated by reference.

This application is related but does not claim priority to the following U.S. provisional applications that were filed on Feb. 22, 2002: No. 60/358,362, No. 60/358,390, No. 60/358,394; No. 60/358,395; No. 60/358,396; No. 60/358,398; No. 60/358,436; and, No. 60/358,439 and any non-provisional patent applications claiming priority to the same.

This application is also related but does not claim priority to U.S. provisional application No. 60/358,737, which was filed on Feb. 25, 2002, and U.S. provisional application No. 60/418,355, which was filed on Oct. 16, 2002, and any non-provisional patent applications claiming priority to the same. The entirety of the subject matter of these applications is incorporated by reference herein.

This application is also related to but does not claim priority to U.S. Design Application 29/155,964 filed on Feb. 22, 2002, and U.S. Design Application 29/156,028 filed on Feb. 23, 2002.

This application is also related to but does not claim priority to U.S. patent application Ser. No. 10/346,188 and U.S. patent application Ser. No. 10/346,189 which were filed on Jan. 17, 2003. The entirety of the subject matter of these applications is incorporated by reference herein.

### BACKGROUND OF THE INVENTION

1. Field of the invention

The present invention relates generally to a three-wheel vehicle, more particularly, to a tiltable steering column for a three-wheel vehicle that provides variable steering positions for a handlebar mechanism.

2. Description of Related Art

Generally, recreational vehicles, such as All Terrain Vehicles (“ATVs”), typically are commercialized with two different riders in mind. The first type of rider seeks an ATV that is a utility vehicle, capable of rugged off-road, back-woods use and designed for carrying equipment, etc. One current example of such an ATV is the Traxter™ ATV manufactured by Bombardier Inc. of Montreal, Quebec, Canada. The second type of rider seeks a high performance ATV that is designed for sport activities. This rider, typically, is not interested in an ATV that is designed for rugged back-woods use or for carrying equipment. One current example of such an ATV is the DS 650™ also manufactured by Bombardier Inc. of Montreal, Quebec, Canada. Other manufacturers of ATVs have commercialized similar vehicles.

Utility and sport ATVs represent extremes in the design of recreational vehicles. Manufacturers also have commercialized vehicles that offer various combinations of utility and sport features. However, to date, no manufacturer has offered a single recreational vehicle that may be adapted to different riders or different riding styles, at least to some extent.

ATVs are not the only types of vehicles that are commercialized around the utility/sport model. As may be appreciated by consumers, other recreational vehicles, including motorcycles and snowmobiles, are also sold in this manner.

For example, Bombardier Inc. manufactures and sells a utility snowmobile known as the Grand Touring™ snowmobile. That vehicle is designed to accommodate more than one individual (in some cases). It is also designed for carrying at least a modest payload. At the other extreme, Bombardier Inc. manufactures and sells the MXZ™ snowmobile, which is a high-performance sport vehicle. As with ATVs, Bombardier Inc. also manufactures several other models of snowmobiles that are hybrid combinations of touring and sport features.

As a subset of the utility/sport spectrum, manufacturers have recognized that purchasers appreciate adjustability in their vehicles.

In particular, consumers appreciate the ability to change the way in which they are positioned on a vehicle depending upon their mood, personality, body type, and ride type, among others. For example, for one riding excursion, a consumer may desire to adjust the riding parameters associated with his vehicle so that the riding position is more aggressive. For another riding excursion, the same rider may wish to have a more touring-style positioning.

It is also common for consumers to want to adjust the parameters that define the riding position so that the vehicle is more comfortable for that particular consumer. While manufacturers such as Bombardier Inc. endeavor to design a vehicle that suits well a large variety of body sizes and types, consumers have individual preferences that are sometimes outside of the optimal engineering parameters. Despite this, no manufacturer has previously offered a recreational vehicle where the consumer may adjust the riding position to suit his or her personal needs.

Motorcycles are also deficient in this regard. As with ATVs and snowmobiles, motorcycles typically are designed around the same basic parameters. Namely, manufacturers usually manufacture and sell at least a touring and a sport motorcycle. To satisfy the wide variety in consumer choice, motorcycle manufacturers also make a variety of vehicles between these two extremes.

Regardless of the type of recreational vehicle considered, the same deficiency in the prior art exists.

This same deficiency exists for three-wheeled vehicles. A few examples of three-wheeled vehicles are disclosed as part of the prior art.

U.S. Pat. No. 4,787,470 (“the '470 patent”) discloses a three-wheel vehicle with two front wheels and a sole rear wheel having a body formed by an ATV frame carrying two front fenders, one rear fender, and a straddle-type seat. The '470 patent describes no features that permit a rider to adjust any of the positioning parameters of the vehicle.

U.S. Pat. No. 4,662,468 (“the '468 patent”) also discloses a three-wheel vehicle with two front wheels and a sole rear wheel. The three-wheel vehicle of the '468 patent uses a conventional snowmobile chassis that is modified by attaching two driving wheels at its front end. This patent also fails to describe any features that permit the operator to change or adjust riding position parameters.

U.S. Pat. No. 5,564,517 (“the '517 patent”) discloses a snowmobile conversion frame kit which includes two wheels with a steering assembly in the front and a rear wheel with a swing arm in the rear. The kit is designed to be secured to a conventional snowmobile chassis. As with the other vehicles, there is nothing in the patent to suggest that the riding parameters of the vehicle may be adjusted in any manner.

As discussed above, a need has arisen for a construction that provides at least a modest degree of adjustability and/or flexibility in rider positioning.

This need remains unaddressed by the prior art.

### SUMMARY OF THE INVENTION

The present invention provides a three-wheel vehicle and an adjustable steering shaft that provides for variable positioning of a handlebar mechanism operatively connected to the steering shaft.

The variable positioning of the handlebar mechanism allows for adjustment of the handlebar mechanism to accommodate riders of different sizes and to provide different riding positions for a rider.

The handlebar mechanism may be positioned further from the seat position to accommodate taller riders and/or to provide a relaxed (e.g., touring) riding position for the rider.

The handlebar may be positioned closer to a defined seat position to accommodate a shorter rider and/or to provide an aggressive (e.g., racing) riding position for the

Accordingly, the present invention provides for a three-wheel vehicle, which includes a frame, a straddle-type seat disposed on the frame, and an engine supported by the frame. At least three wheels are suspended on the frame, a first wheel being at a front and a second wheel being at a rear of the frame. At least one of the three wheels is operatively driven by the engine. The vehicle also includes a steering shaft operatively connected to at least one of the three wheels and a steering bracket that supports the steering shaft in a plurality of selective positions.

Other aspects of the present invention will be made apparent from the description that follows.

### BRIEF DESCRIPTION OF THE DRAWINGS

For a better understanding of the present invention as well as other objects and further features thereof, reference is made to the following description which is to be used in conjunction with the accompanying drawings, where:

FIG. 1 is front view of a three-wheel vehicle according to the present invention;

FIG. 2 is a side view of the vehicle shown in FIG. 1;

FIG. 3A is a top view of the vehicle shown in FIGS. 1 and 2;

FIG. 3B is a top view of an alternate embodiment of the vehicle shown in FIGS. 1 and 2;

FIG. 4 is a perspective view of a frame assembly according to the present invention, as viewed from the rear left side;

FIG. 5 is a perspective view of the frame assembly, as viewed from the forward left side;

FIG. 6 is a left side view of the frame assembly;

FIG. 7 is a top view of the frame assembly;

FIG. 8 is a rear view of the frame assembly;

FIG. 9 is a partial side view of the frame assembly and a steering shaft of the steering assembly in a first position according to the present invention;

FIG. 10 is a perspective view of the frame assembly, including the steering assembly and fuel tank, as viewed from the forward left side;

FIG. 11 is a perspective view of the frame assembly, including the steering assembly and fuel tank, as viewed from the rear left side;

FIG. 12 is a close-up left side view detail of the connection point between the handlebars and the frame assembly, illustrating the variable positioning of the handlebars;

FIG. 13 is a perspective view of the steering shaft, the front left wheel and a portion of the steering assembly as viewed from the rear right side;

FIG. 14 is a perspective view of the steering shaft, the front left wheel and a portion of the steering assembly as viewed from the front left side;

FIG. 15 is a schematic illustration of an adjustable steering shaft arrangement according to an embodiment of the present invention;

FIG. 16 is a schematic illustration of a connection of the adjustable steering shaft shown in FIG. 15 to a front suspension sub-frame;

FIG. 17 is a schematic illustration of an adjustable steering shaft arrangement according to another embodiment of the present invention; and

FIG. 18 is a schematic illustration of an adjustable steering shaft arrangement according to another embodiment of the present invention.

### DETAILED DESCRIPTION

Before delving into the specific details of the present invention, it should be noted that the conventions “left,” “right,” “front,” “rear,” “up,” and “down” are defined according to the normal, forward travel direction of the vehicle being discussed. As a result, the “left” side of a vehicle corresponds to the left side of a rider seated in a forward-facing position on the vehicle.

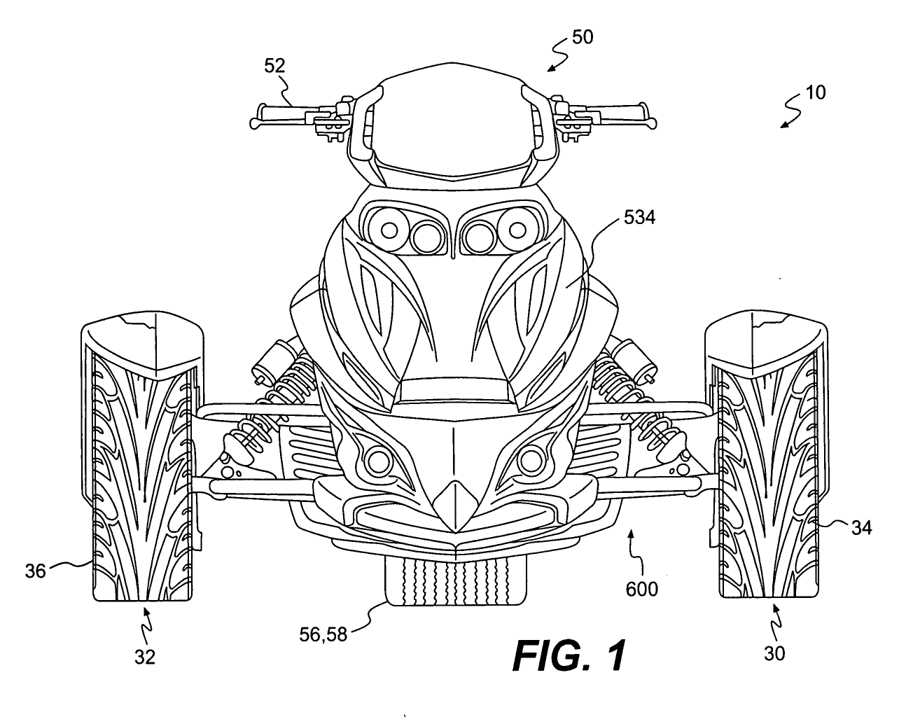

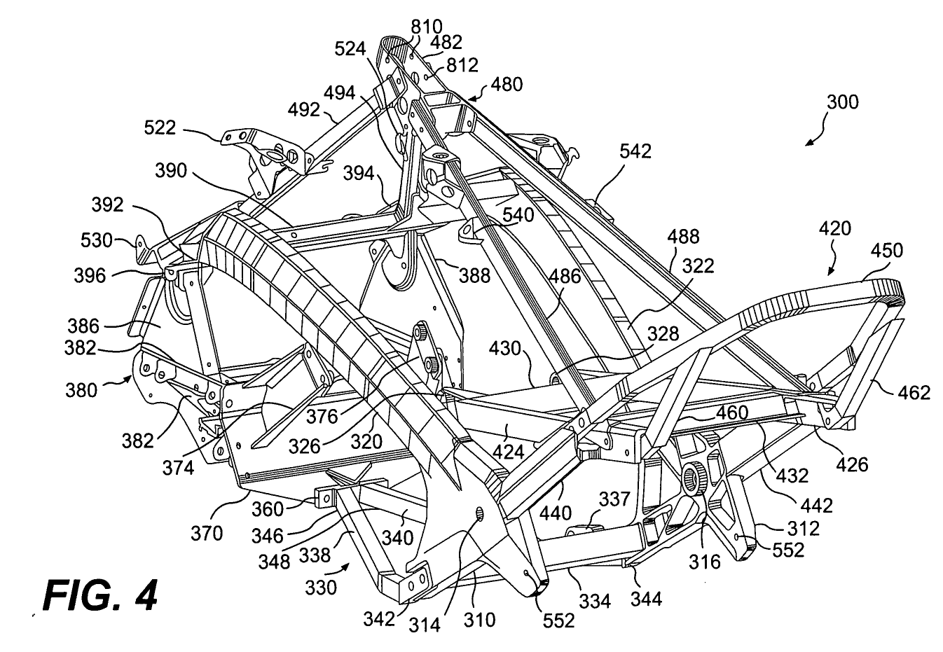

FIGS. 1-3A illustrate a three-wheel vehicle 10 according to the present invention. Left and right laterally spaced front wheels 30, 32, with left and right tires 34, 36, are supported by a front suspension system 600. The front suspension system 600 is supported by a frame assembly 300 (FIG. 4). A steering assembly 50 is mounted to the frame assembly 300 and includes a handlebar mechanism 52 that is operatively connected to the front wheels 30, 32 to steer the vehicle 10. The steering assembly 50 is preferably a progressive steering system.

A rear wheel 56 and tire 58 are supported by a rear suspension system 60. The rear suspension system 60 is supported by the frame assembly 300. For purposes of the following description, it should be appreciated that the rear wheel 56 may be include a single rim or may include a multi-rim arrangement having a rigid connection between the rims to form the wheel. It should also be appreciated that each rim accommodates a tire. In the case of a multi-rim arrangement, the plurality of rear tires may be in contact with one another or spaced from each other or a combination of spaced and touching.

The wheels 30, 32, 56 are all preferably 15 inch wheels. The tires 34, 36, 58 preferably are automotive tires suitable for road use. It would be appreciated by those skilled in the art, however, the wheels 30, 32, 56 may be of any other size without deviating from the scope of the present invention.

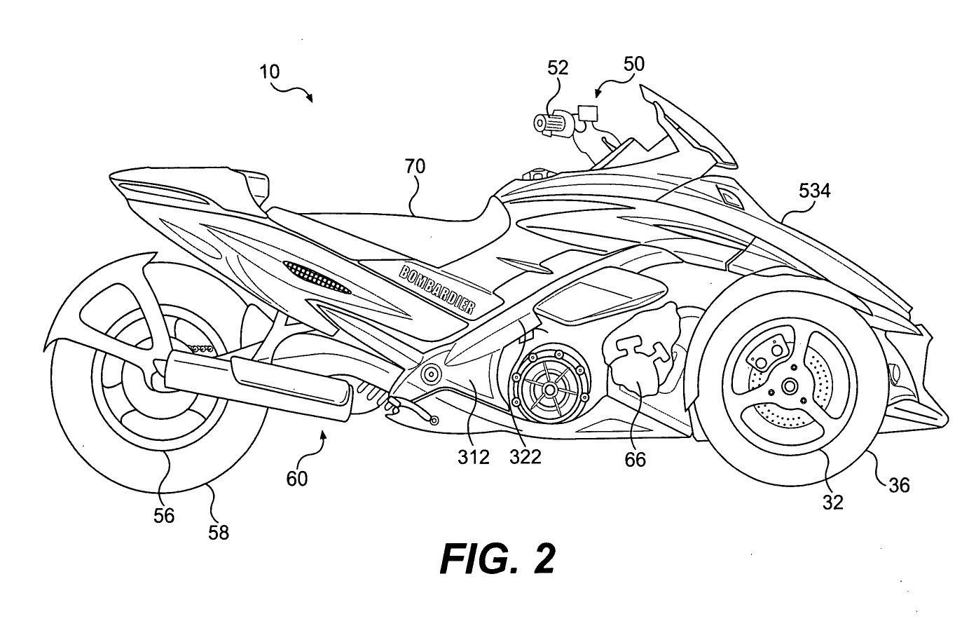

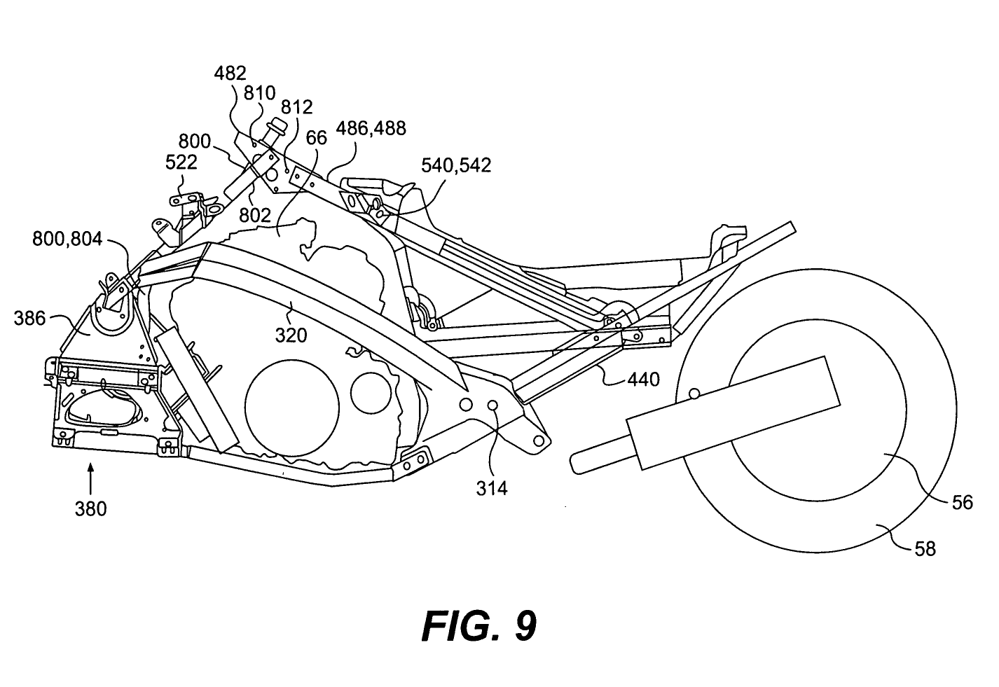

An engine 66 (FIGS. 2 and 9) is supported by the frame assembly 300 and operatively connected to the rear wheel 56 to power the vehicle 10. It should be appreciated that the engine, alternatively, may be operatively connected to one or both of the front wheels, or to all of the wheels.

Since the vehicle 10 is designed for road use, the engine 66 preferably is selected to produce an output power of 75 horsepower or more. A 1000 cc ROTAX™ V-type internal combustion engine is preferred. However, any other engine size or type of engine may be used instead. Moreover, the engine 66 may be designed to produce less than 75 horsepower without deviating from the scope of the present invention. In addition, a fuel cell or electric motor may be used instead of the engine 66.

Preferably, the frame assembly 300 is designed to provide sufficient structural rigidity so that the frame assembly 300 withstands the forces experienced during high performance operation of the vehicle 10.

A cushioned rider seat 70 is mounted to the frame assembly 300 between the forward wheels 30, 32 and the rear wheel 56.

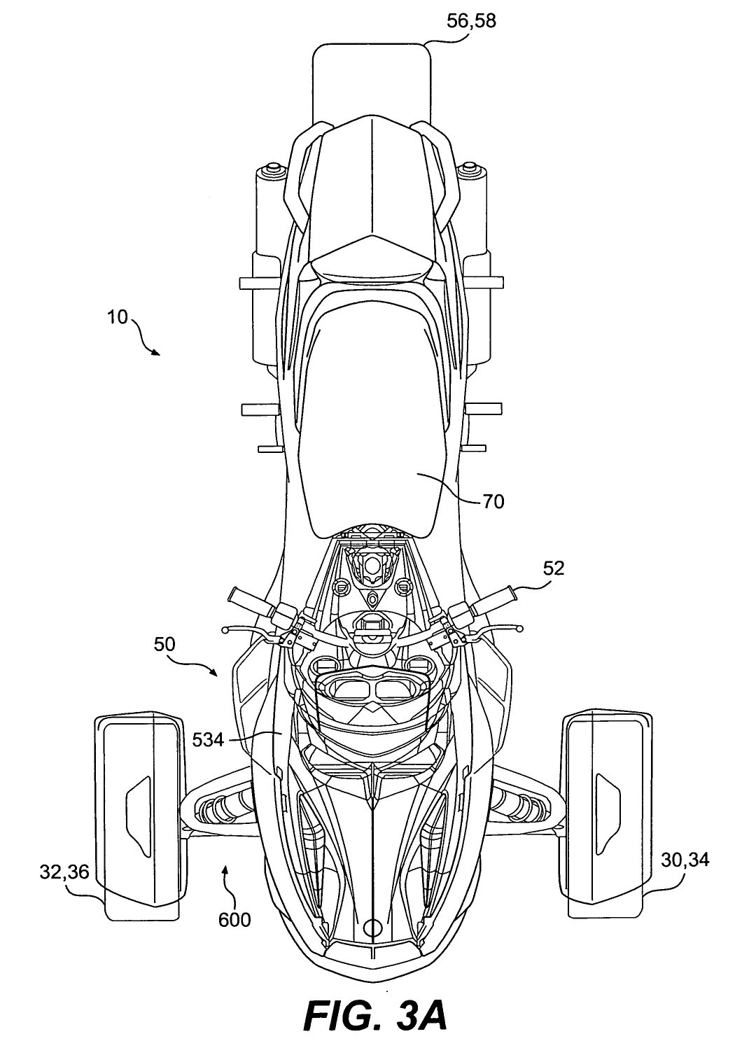

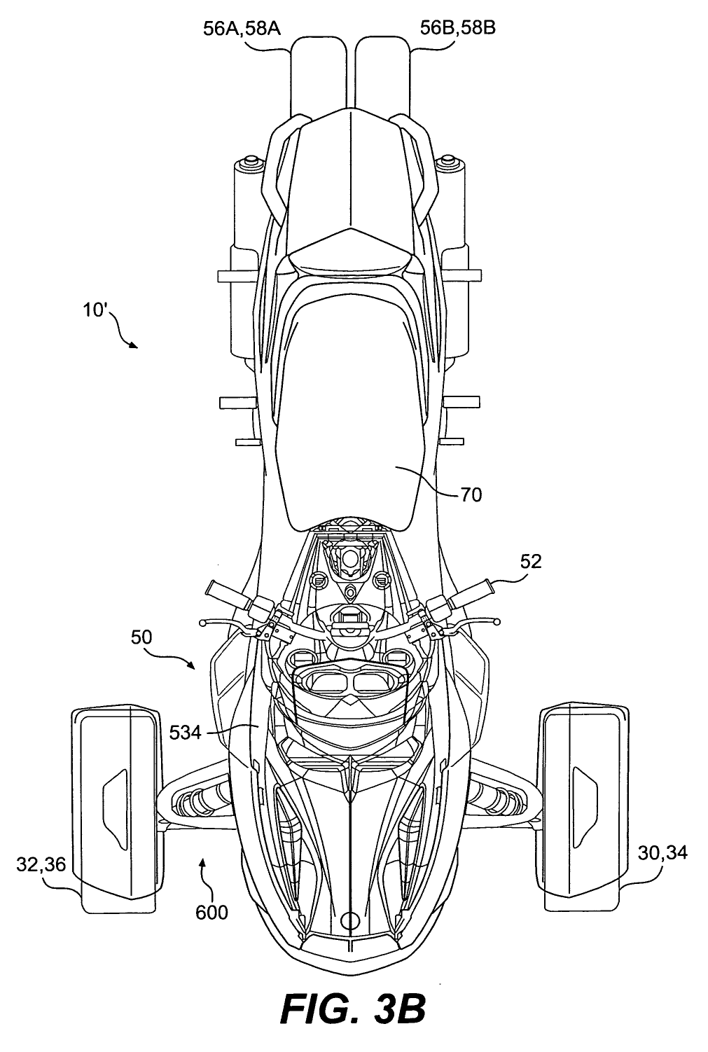

Referring to FIG. 3B, an alternate embodiment of a three-wheel vehicle 10′ according to the present invention includes a plurality of rear wheels and tires 56A, 56B and 58A, 58B. While two rear wheels 56A, 56B are shown, any number greater than two also may be employed without deviating from the scope of the present invention.

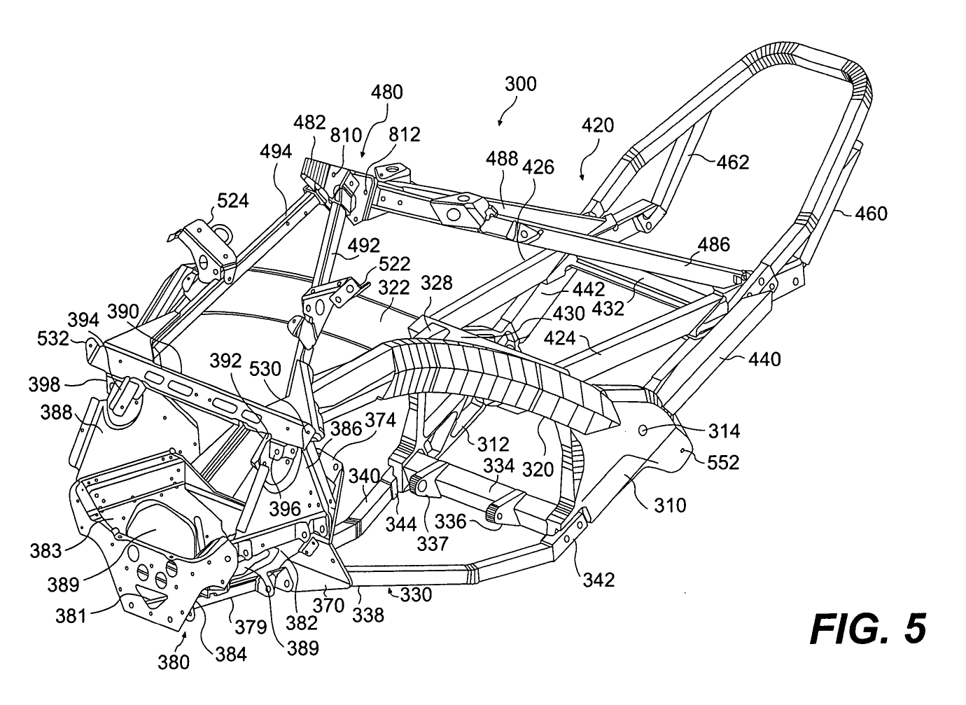

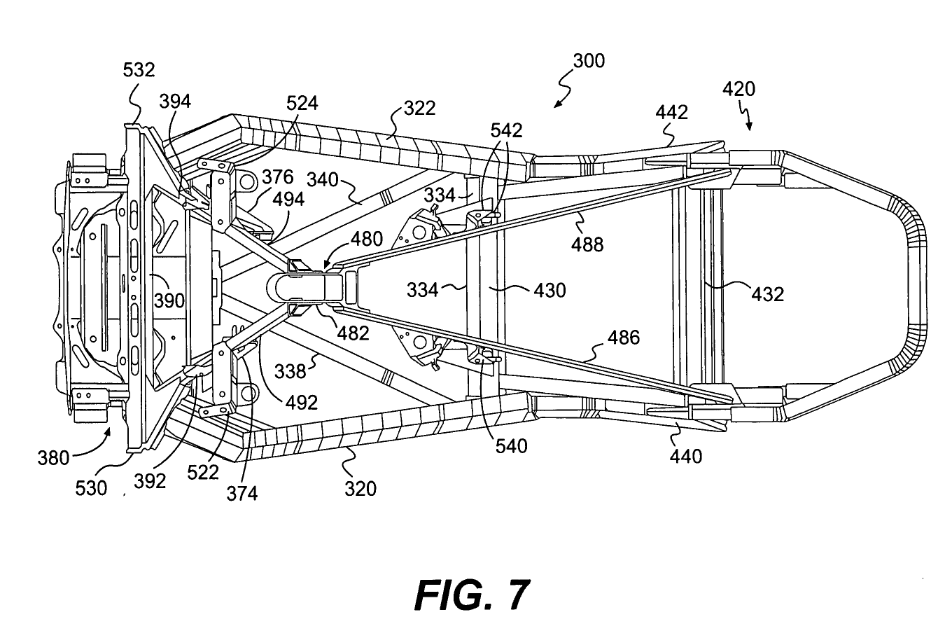

Referring to FIGS. 4-10, the frame assembly 300 of the vehicle 10 includes left and right laterally spaced rear suspension plates 310, 312. The rear suspension plates 310, 312 generally form vertically and longitudinally extending reinforced plates. The rear suspension plates 310, 312 are preferably made of a strong light material such as cast aluminum. Left and right laterally extending swing arm pivot bores 314, 316 are centrally disposed on each rear suspension plate 310, 312 to accommodate pivotal mounting of a rear swing arm 400 (FIG. 9).

Laterally spaced left and right upper spars 320, 322 extend upwardly and forwardly from upper forward portions of the left and right rear suspension pates 310, 312, respectively. While not required, the upper spars 320, 322 in this embodiment are welded or otherwise integrally formed with the rear suspension plates 310, 312. The upper spars 320, 322 extend arcuately slightly upwardly as they progress forwardly to provide an attractive shape to the frame assembly 300 when viewed from the side. As illustrated in FIG. 2, the outer sides of the right upper spar 322 is visible from the right side of the vehicle 10. The left upper spar 320 is similarly visible from the left side of the vehicle 10.

An engine cradle assembly 330 extends forwardly from the lower front ends of the rear suspension plates 310, 312. The engine cradle assembly 330 includes a rear engine support cross brace 334 that extends laterally between the lower front ends of the left and right rear suspension plates 310, 312. Laterally spaced left and right lower rear engine anchors 336, 337 extend forwardly from the engine support cross brace 334. The lower rear engine anchors 336, 337 are preferably welded to the engine support cross brace 334.

The engine cradle assembly 330 also includes left and right lower spars 338, 340 having rearward portions 342, 344 that are bolted to the lower forward ends of the left and right rear suspension plates 310, 312, respectively. The lower spars 338, 340 extend forwardly and laterally inwardly from their respective rearward portions to their forward portions 346, 348. A laterally extending lower spar bracket 360 is connected to the forward portions 346, 348 of the lower spars 338, 340. The lower spar bracket 360 is preferably welded to the forward portions 346, 348 of the lower spars 338, 340. The left and right lower spars 338, 340 and the engine support cross brace 334 generally form a triangle when viewed from above.

The engine cradle assembly 330 further includes a forward engine cradle plate 370 that is connected, preferably with bolts, to a forward portion of the lower spar bracket 360. The plate 370 generally extends vertically and laterally and includes several small bends along lateral fold lines that improve the rigidity of the plate 370. Left and right forward engine anchors 374, 376 extend rearwardly and upwardly from the plate 370 and include engine mounting holes. The engine anchors 374, 376 are preferably welded or otherwise permanently fixed to the engine cradle plate 370.

As the rearward portions 342, 344 of the lower spars 338, 340 are bolted to the rear suspension plates 310, 312 and the lower spar bracket 360 is bolted to the engine cradle plate 370, the lower spars 338, 342 and the lower spar bracket 360 may be detached from the frame assembly 300 in order to provide access to the engine without further disassembly of the components of the frame assembly 300.

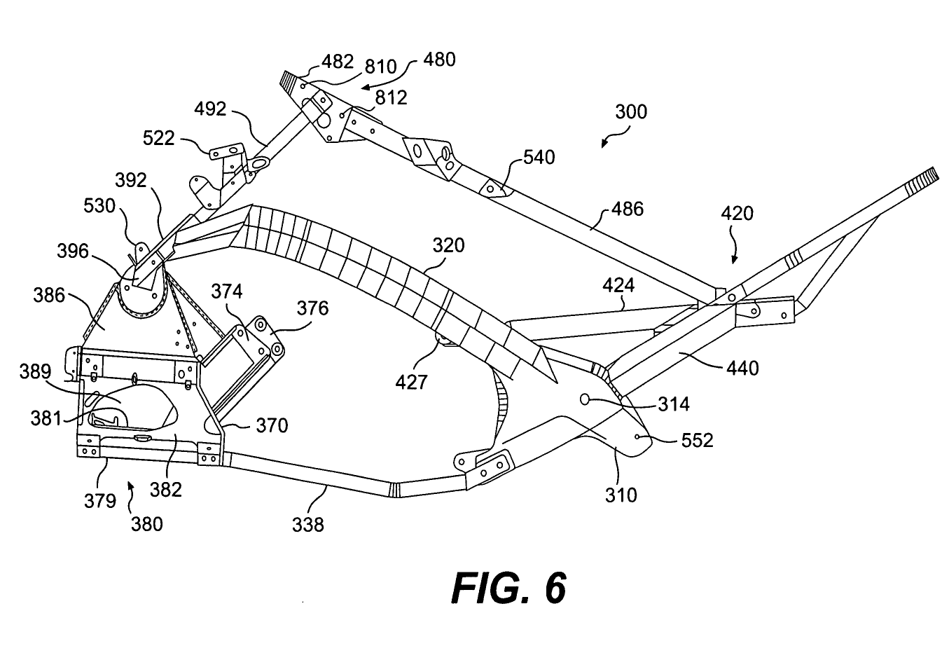

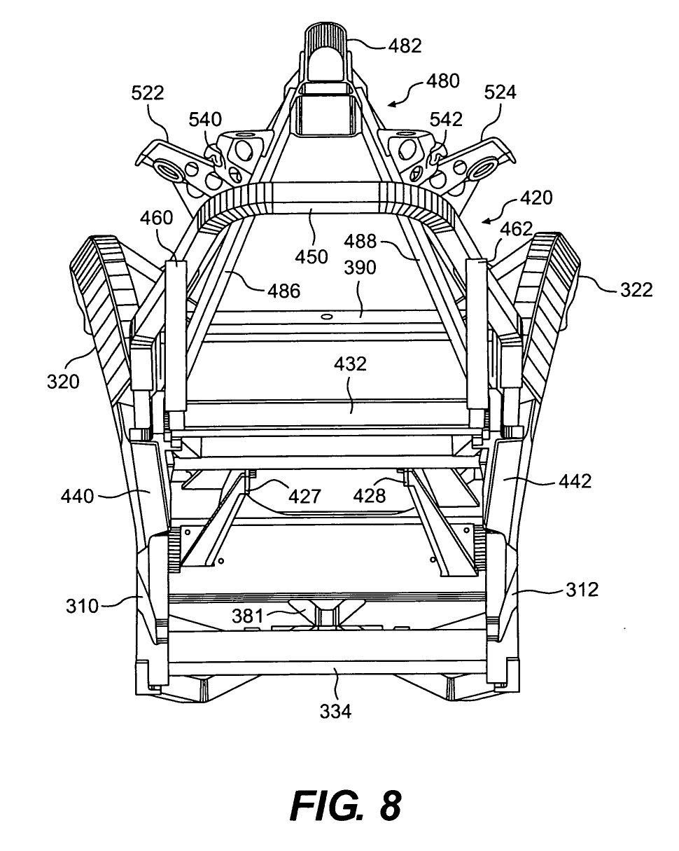

A front suspension sub-frame 380 is connected, preferably with bolts, to a forward end of the engine cradle plate 370. The front suspension sub-frame 380 includes a longitudinally extending tubular beam 381. The beam 381 is an extruded hollow member having a generally trapezoidal or triangular cross section with the long parallel edge of the trapezoid on top (FIG. 8). A generally V-shaped plate 379 includes left and right outwardly extending side panels 382, 383 that extend upwardly, outwardly and longitudinally from a generally flat longitudinally-oriented vertex. The V-shaped plate 379 forms a “V” when viewed from the front. The tubular beam 381 is connected, preferably by welding, to the inside of the vertex of the V-shaped plate 379 to form a V-shaped assembly. The outwardly extending side panels 382, 383 include large central apertures 389 through which tie rods 55 of the steering assembly 50 extend. The rear edge of the V-shaped assembly is connected, preferably by rivets, welds or bolts, to the engine cradle plate 370, whose lateral bends follow the rear edge of the V-shape assembly (FIG. 6).

The sub-frame 380 further includes a vertically and laterally extending forward transverse plate 384 that is connected, preferably with welds, rivets or bolts, to the front end of the V-shaped assembly. Together, the variously oriented plates/panels 370, 382, 383 384 and the tubular beam 381 provide a strong, rigid front suspension sub-frame 380 onto which the front suspension 600 is mounted.

Left and right vertically and longitudinally extending side panels 386, 388 extend upwardly from the left and right outwardly extending panels 382, 383, respectively, of the V-shaped assembly. Each side panel 386, 388 forms a triangle having a flat lower side attached to the flat upper edge of the corresponding outwardly extending side panel 382, 383 of the V-shaped assembly. Each vertically extending side panel 386, 388 may be welded to its corresponding outwardly extending side panel 382, 383. Alternatively, each vertically extending side panel 386, 388 may be integrally formed with its corresponding outwardly extending side panel 382, 383, a bend in the sheet material of the V-shaped plate 379 defining the attachment edge between adjoining panels 382, 386 and 383, 388.

A laterally extending front cross brace 390 connects between upper ends of the side panels 386, 388 (i.e., at the upper vertices of the triangles formed by the side panels 386, 388) of the front suspension sub-frame 380 at left and right connection points 392, 394. Forward ends of the left and right upper spars 320, 322 likewise connect to the front cross brace at the left and right connection points 392, 394, respectively. The front cross brace 390 extends laterally outwardly beyond the connection points 392, 394 on its left and right sides to provide left and right shock absorber anchors 396, 398. The front cross brace 390 preferably bolts, or otherwise removably fastens, to the front suspension sub-frame 380 and the upper spars 320, 322.

A pyramid-shaped upper structural support assembly 480 extends upwardly from left and right tank support members 424, 426 and connection points 392, 394 to a steering column bracket 482. Left and right upper column rear members 486, 488 connect between the rearward portions of the left and right tank support members 424, 426, respectively, and the steering column bracket 482. Each upper column rear member 486, 488 extends upwardly, forwardly, and inwardly from the rearward portion of its respective tank support member 424, 426 to the steering column bracket 482. Consequently, the left upper column rear member 486, right upper column rear member 488, and the rearward suspension cross brace 432 generally form a triangle when viewed from the rear and/or top.

The upper structural support assembly 480 further comprises left and right upper column front members 492, 494 connected between the left and right connection points 392, 394, respectively, on the front cross brace 390 and the steering column bracket 482. Each upper column front member 492, 494 extends upwardly, rearwardly, and inwardly from its respective connection point 392, 394 on the front cross-brace 390 to the steering column bracket 482. Consequently, the upper column front members 492, 494 and front cross brace 390 generally form a triangle when viewed from the front and/or top.

The steering column bracket 482 may alternatively be mounted to any other convenient portion of the frame assembly 300. For example, if the upper support assembly 480 were eliminated, a steering column bracket could be supported by a cross brace that extends between the upper spars 320, 322. Alternatively, the steering column bracket could be supported by one or both of the upper spars 320, 322 directly. Generally, the steering shaft 53 may be pivotally connected to any two frame assembly 300 components, e.g., the front suspension sub-frame 380, the upper spars 320, 322, the upper support assembly 480, front cross brace 390, etc. The steering shaft 800 may alternatively be pivotally connected to just one frame assembly 300 component.

While the pyramid-shaped upper support assembly 480 is not required for the structural strength and/or rigidity of the frame assembly 300, the upper support assembly 480 provides anchor points for a variety of vehicle 10 components. For example, the fuel tank 481 is supported by the upper support assembly 480. The upper support assembly 480 need not be included in a frame assembly 300 according to the present invention. For example, if the upper support assembly 480 were eliminated, a steering bracket like the steering column bracket 482 could be mounted to any other suitable component of the frame assembly 300. Similarly, other components that are illustrated as being mounted to the upper support assembly 480 could either be eliminated, moved or mounted to other frame assembly 300 components without deviating from the scope of the present invention.

Left and right forward upper fairing anchors 522, 524 are mounted at intermediate portions of the left and right front braces 492, 494, respectively. Similarly, left and right forward lower fairing anchors 530, 532 are formed at the left and right ends of the front cross brace 390. The forward fairing 534, which is preferably made of fiberglass with a gelcoat, is attached to the body anchors 522, 524, 530, 532.

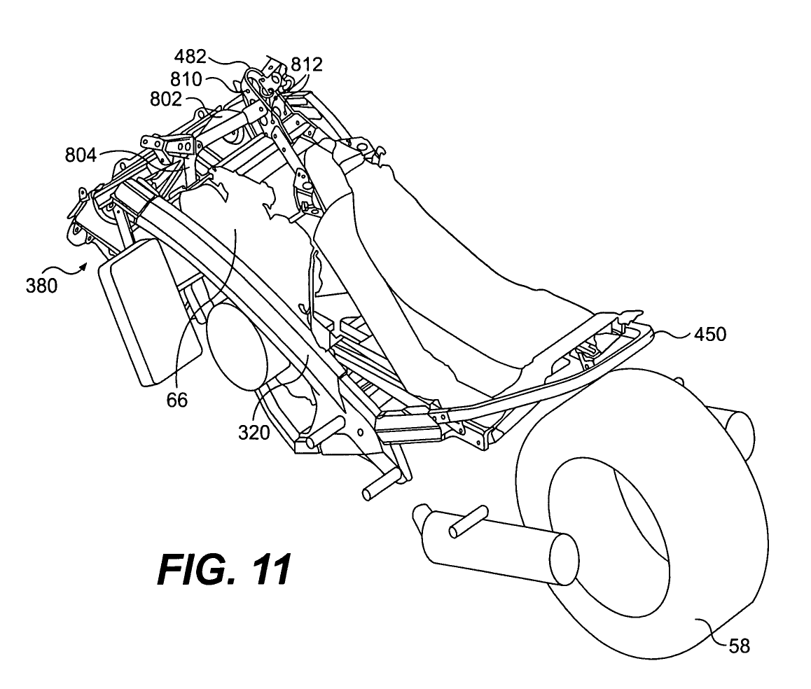

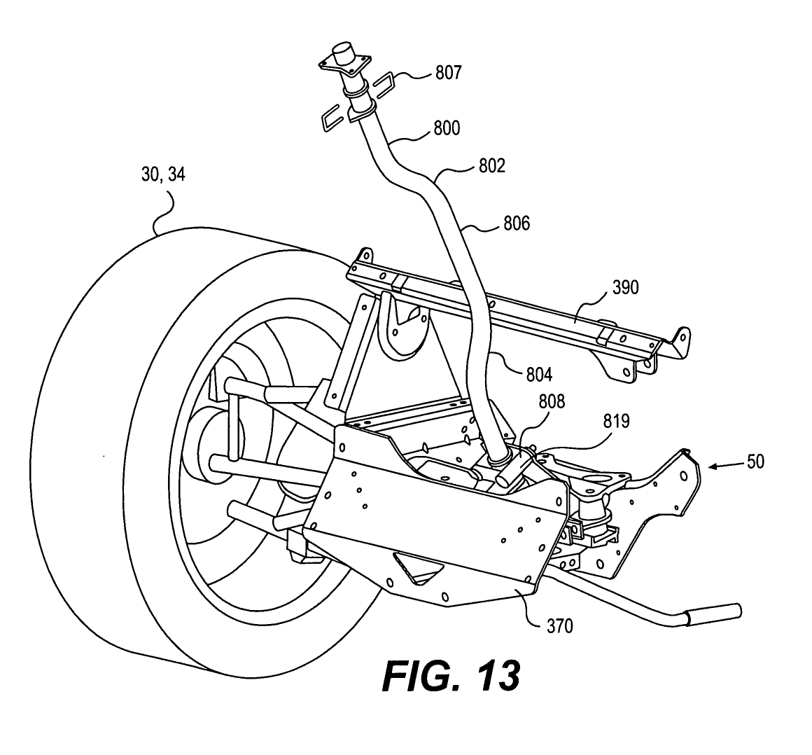

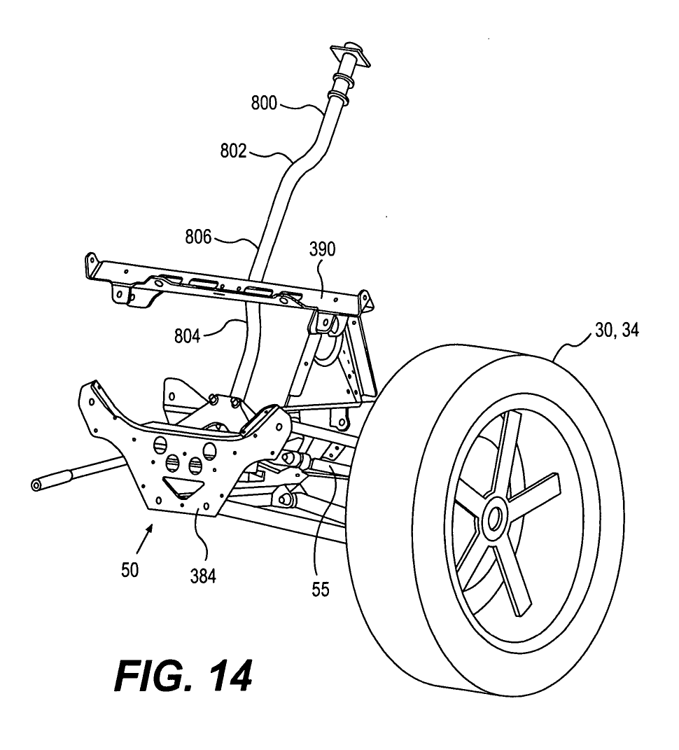

Referring to FIGS. 9-16, a steering shaft 800 is connected to the handlebar mechanism 52 at an upper end of the steering shaft 800. The steering shaft 800 is connected at a bottom end thereof to a bearing or bushing 808 (FIG. 13) connected to the steering assembly 50 that turns front wheels 30, 32 upon rotation of the handlebar mechanism 52. To accommodate the variable positioning of the steering shaft 800 and the handlebar mechanism 52, the steering shaft 800 includes upper and lower bends 802, 804 that provide an offset portion 806 of the steering shaft 800. The offset portion 806 ensures that the steering shaft 800 remains spaced from the engine 66 when moved from a first position 814 to a second position 816.

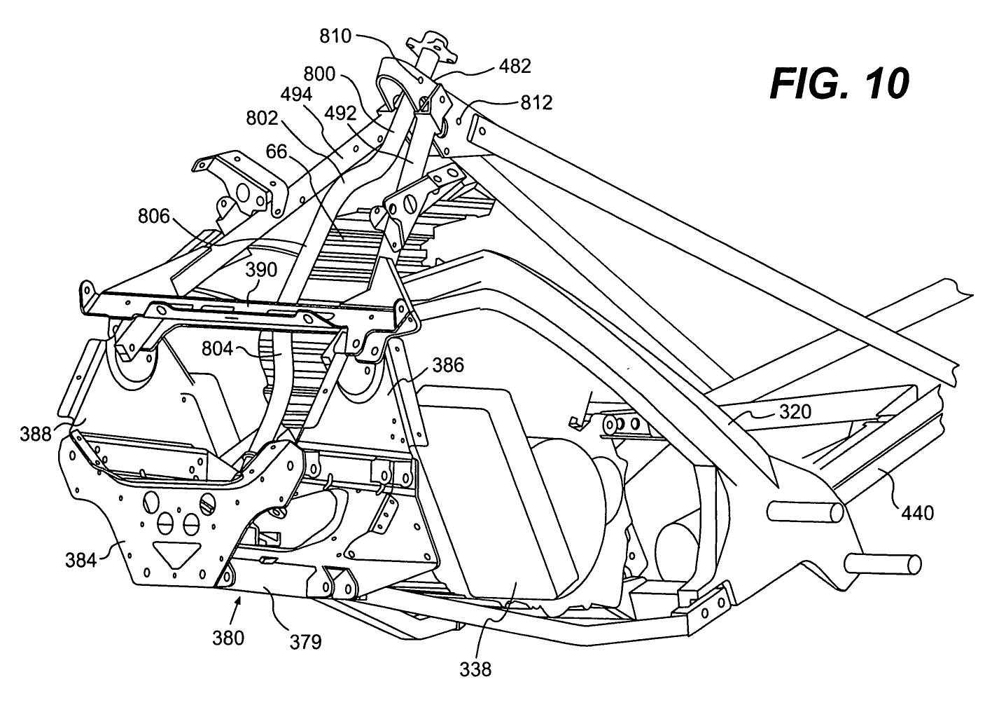

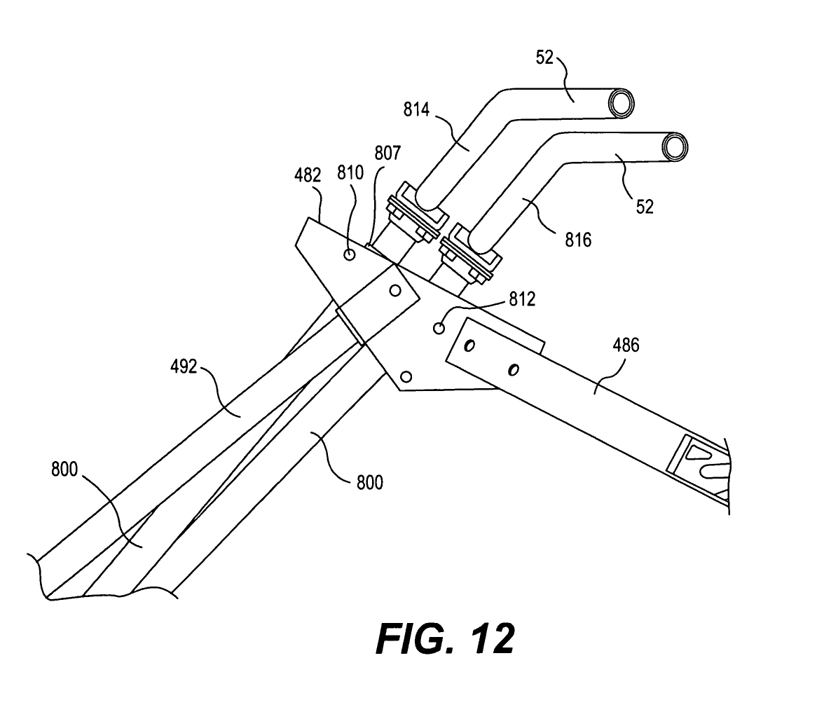

Referring to FIGS. 12-14, the steering shaft 800 passes through a bearing or bushing 807 at its upper end that is connected to the steering bracket 482 at either first or second pairs of holes 810, 812. The pairs of holes 810, 812 define the first and second positions 814, 816 of the steering shaft 800. It should be appreciated that a single hole on one side of the steering bracket 482 may define a position of the steering shaft 800. Referring to FIGS. 9 and 10, the steering shaft 800 is shown in the first position 814. When the steering shaft 800 is moved to the second position 816, the offset portion 806 remains spaced from the engine 66. As shown in FIG. 9, the steering shaft 800 is shown in the first position 814 spaced from the engine 66. A straight steering shaft would be spaced from the engine 66 in the first position 814. However, in order to allow for variable positioning of the steering shaft 800, the offset portion 806 is necessary to ensure that the steering shaft 800 remains spaced from the engine 66 when the steering shaft 800 is moved from the first position 814 to the second position 816.

The position of the steering shaft 800 in front of the engine provides several advantages, some of which are detailed below.

First, with the steering shaft in front of the engine 66, the engine 66 may be positioned in the frame assembly 300 at a lower position than would be possible if the engine 66 were positioned in front of the steering shaft 800. Moreover, the engine 66 may be placed in a position that is more centrally located than if the engine were positioned in front of the steering shaft 800. The placement of the engine 66 in the location generally illustrated in FIG. 9 assures that the vehicle 10 will have a low center of gravity that is more centrally positioned beneath the operator of the vehicle. With the center of gravity of the vehicle positioned in this manner, the vehicle is very stable, even at higher speeds, as would be experienced during road use.

Second, positioning the steering shaft 800 in front of the engine 66 facilitates access to the engine 66 after the engine cradle assembly 330 is removed. With the steering shaft 800 positioned in front of the engine 6, there are no steering components that extend rearwardly and beneath the engine. As a result, the engine is more accessible when the engine cradle assembly is removed.

Other advantages of the positioning of the steering shaft 800 in front of the engine 66 may be appreciated by those skilled in the art.

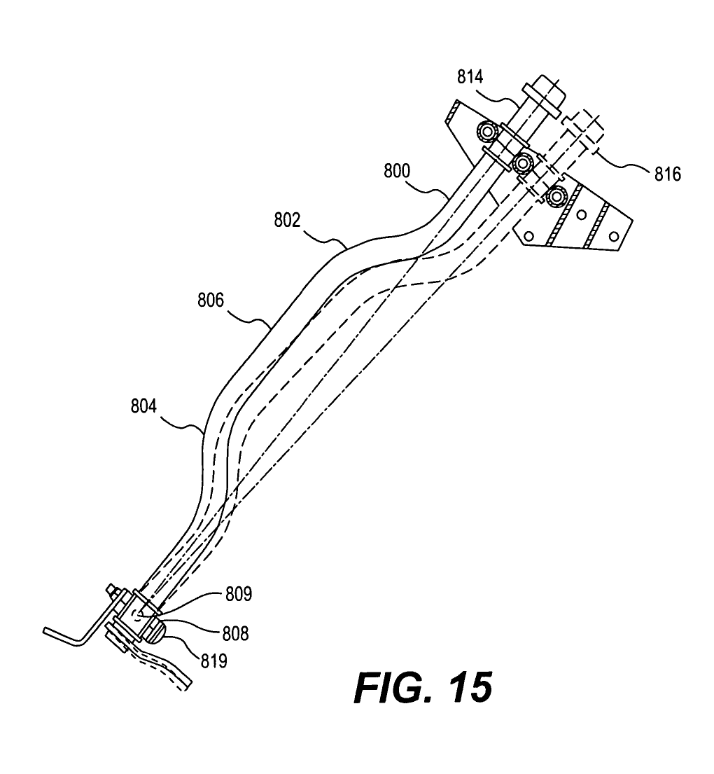

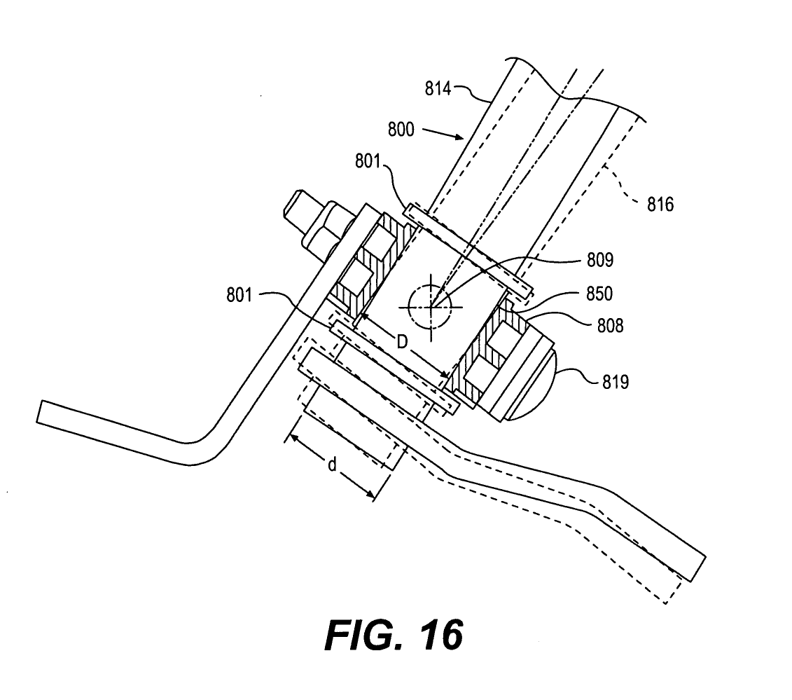

Referring to FIGS. 15 and 16, the lower end of the steering shaft 800 is supported by the bearing or bushing 808 and pivots about a pivot point 809. The bearing or bushing 808 includes a bore 850 through which the steering shaft 800 passes. The bore 850 has a diameter D that is larger than the diameter d of the steering shaft 800. As shown in FIGS. 13 and 16, the bearing or bushing 808 includes separable parts secured together by a fastener 819. The steering shaft 800 has flanges 801 on the lower end that allow the steering shaft 800 to pivot about the pivot point 809 and prevent the steering shaft 800 from being removed from the bearing or bushing 808 in a longitudinal direction of the bore 850.

The adjustability of the steering shaft 800, and the adjustability of the handlebar mechanism 52, allows the handlebar mechanism 52 to be positioned closer to the rider in the second position 816 to allow for a more aggressive, or racing, riding stance. The handlebar mechanism 52 may also be positioned farther from the rider in the first position 814 to provide a more relaxed, or touring, riding stance. The steering shaft 800 thus has two positions for a single rider or a different positions for different riders. The adjustability of the steering shaft 800 also accommodates different size upper bodies and arm lengths of various riders.

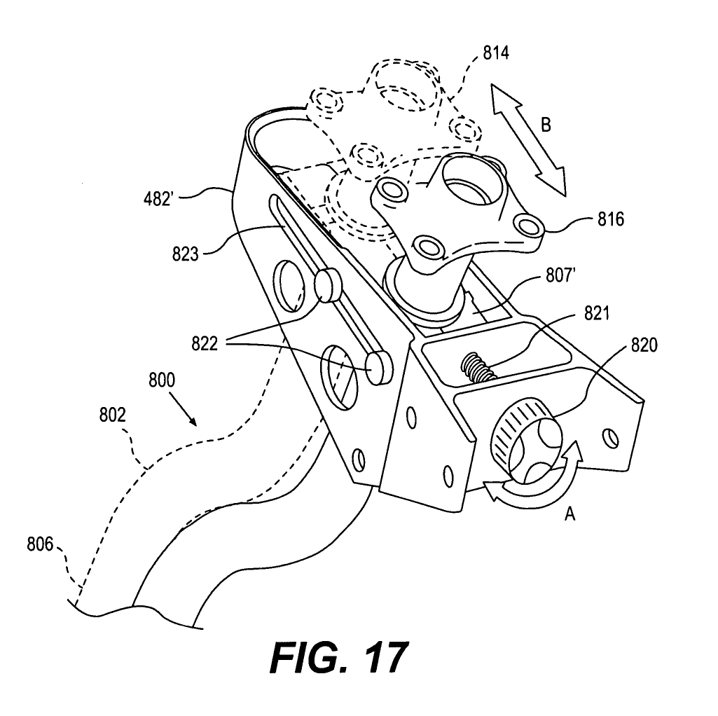

Although the steering bracket 482 is shown with two pairs of holes 810, 812 that define two positions of the steering shaft 800, it should be appreciated that the steering bracket 482 may be constructed to provide for more than two positions by the provision of additional pairs of holes or to provide infinite variation of the position of the handlebar mechanism 52, such as by the provision of a slot. Referring to FIG. 17, a steering bracket 482′ according to an alternate embodiment of the present invention includes a slot 823 that accepts projections 822 of a bearing or bushing 807′. It should be appreciated that the bearing or bushing 807′ may have a single projection. The bearing or bushing 807′ receives a threaded member 821. A knob 820 is fixed to the threaded member 821 and is rotatable as indicated by arrow A. Rotation of the knob 820 causes the bearing or bushing 807′ to move in the direction of arrow B along the slot 823. Rotation of the knob 820 and movement of the bearing or bushing 807′ provides an infinite number of positions for the steering shaft 800.

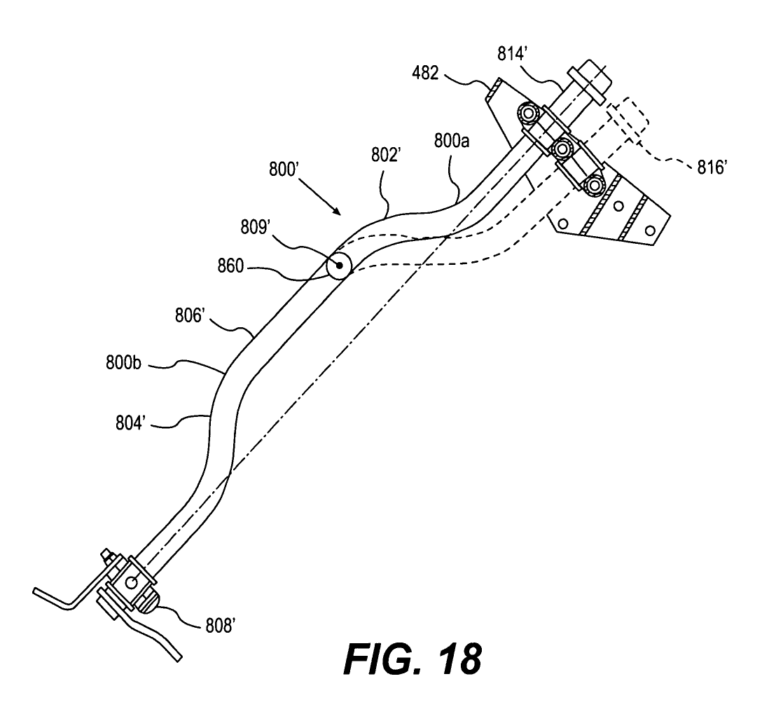

Referring to FIG. 18, an alternate embodiment of a steering shaft 800′ according to the present invention includes a pivot point 809′ that is positioned intermediate the ends of the steering shaft 800′. An articulated member 860, for example a hinge, a universal joint, a crown spline joint, or an elastic member, formed for example of rubber, is provided between the ends of the steering shaft 800′ and allows a top portion 800a of the steering shaft 800′ to pivot between a first position 814′ and a second position 816′. A lower portion 800b of the steering shaft 800′ is fixed in a bearing 808′. Although the articulated member 860 is shown in the offset portion 806′, it should be appreciated that the articulated member 860 may be provided intermediate the upper bend 802′ and the upper end of the steering shaft 800′, or between the lower bend 804′ and the lower end of the steering shaft 800′, or at any position intermediate the ends of the steering shaft 800′. It should also be appreciated that the steering shaft 800′ may be used with a positioning device similar to the positioning device shown in FIG. 12 or with a positioning device similar to the positioning device shown in FIG. 17.

The foregoing illustrated embodiments are provided to illustrate the structural and functional principles of the present invention and are not intended to be limiting. To the contrary, the principles of the present invention are intended to encompass any and all changes, alterations and/or substitutions within the spirit and scope of the invention.

What is claimed is:

1. A three-wheel vehicle, comprising:
a frame;
a straddle-type seat disposed on the frame;
an engine supported by the frame;
at least three wheels suspended on the frame, a first wheel being at a front and a second wheel being at a rear of the frame, wherein at least one of the three wheels is operatively driven by the engine;
a steering shaft operatively connected to at least one of the three wheels; and
a steering bracket that supports the steering shaft in a plurality of selective positions.

2. A vehicle according to claim 1, wherein the steering bracket includes a plurality of holes, each pair defining a selected position of the steering shaft.

3. A vehicle according to claim 1, wherein the steering shaft includes first and second bends and an offset portion between the first and second bends.

4. A vehicle according to claim 1, further comprising a bearing that supports the steering shaft, wherein the first bearing is connected to the steering bracket.

5. A vehicle according to claim 1, further comprising a bearing that supports the steering shaft, wherein the bearing is connected to a steering assembly operatively connected between the steering shaft and the at least one wheel operatively connected to the steering shaft.

6. A vehicle according to claim 3, further comprising first and second bearings that support the steering shaft, wherein the first bearing is connected to the steering bracket, the second bearing is connected to a steering assembly of the vehicle and the offset portion is positioned between the first and second bearings.

7. A vehicle according to claim 1, wherein the frame includes left and right upper column front members and left and right upper column rear members, wherein the members define a pyramid shaped structure.

8. A vehicle according to claim 7, wherein the steering bracket is attached to an apex of the pyramid shaped structure.

9. A vehicle according to claim 8, wherein the frame includes an engine cradle below the apex and the engine is attached to the frame within the engine cradle.

10. A vehicle according to claim 9, wherein the steering bracket defines at least a first position where the steering shaft is spaced a first distance from the engine and a second position where the steering shaft is spaced a second distance from the engine, and the first distance is greater than the second distance.

11. A vehicle according to claim 1, wherein the at least three wheels comprises two front wheels and a single rear wheel.

12. A vehicle according to claim 1, wherein the at least three wheels each include a tire suitable for road use.

13. A vehicle according to claim 1, wherein the at least one wheel operatively connected to the engine is a rear wheel.

14. A vehicle according to claim 1, wherein the at least one wheel operatively connected to the engine is a front wheel.

15. A vehicle according to claim 1, wherein the at least three wheels comprise four wheels including two front wheels and two rear wheels.

16. A vehicle according to claim 1, wherein at least a portion of the steering shaft is pivotable amongst the plurality of selective positions.

17. A vehicle according to claim 16, wherein the steering shaft is supported by the steering bracket at a first end and pivotally supported at a second end opposite the first end.

18. A vehicle according to claim 17, wherein the second end is pivotally supported by a bearing at the second end.

19. A vehicle according to claim 16, wherein the steering shaft is supported by the steering bracket at a first end and supported at a second end opposite the first end, and the portion of the steering shaft is pivotable about a point between the first and second ends by an articulated member.

20. A vehicle according to claim 17 or 19, wherein the first end of the steering shaft is supported by a bearing in the steering bracket, the bearing being supported in the steering bracket movable relative to the bracket, and a threaded member operatively connects the bearing to the steering bracket to move the bearing amongst the plurality of selective positions.

21. A vehicle according to claim 19, wherein the articulated member is one of a hinge, a universal joint, a crown spline joint, and an elastic member.
